(19) United States
(12) Patent Application Publication
(10) Pub. No.: US 2026/0369071 A1
(43) Pub. Date: Nov. 19, 2026

(54) ENVIRONMENT PERCEPTION SYSTEM AND METHOD FOR PERCEIVING AN ENVIRONMENT OF A VEHICLE

(71) Applicant: Continental Autonomous Mobility Germany GmbH, Ingolstadt (DE)

(72) Inventor: Bhanu Prakash PADIRI, Bangalore (IN)

(73) Assignee: Continental Autonomous Mobility Germany GmbH, Ingolstadt (DE)

(21) Appl. No.: 19/132,284

(22) PCT Filed: Nov. 16, 2023
(86) PCT No.: PCT/EP2023/082019

§ 371 Date: May 22, 2025

(30) Foreign Application Priority Data
Nov. 22, 2022 (IN) 202241067124
Apr. 20, 2023 (GB) 2305782.1

(51) Int. Cl. G06V 20/58; G06T 7/11; G06V 10/764; G06V 10/776; G06V 10/80; G06V 10/82

(52) U.S. Cl. CPC G06V 20/58; G06T 7/11; G06V 10/764; G06V 10/776; G06V 10/803; G06V 10/82; G06V 2201/07

(57) ABSTRACT

According to various embodiments, a computer-implemented method for perceiving an environment of a vehicle may include segmenting first sensor data into a first plurality of regions, recognizing patterns or detecting objects in each region of the first plurality of regions, classifying each region of the first plurality of regions as one of valid region and invalid region based on at least one of recognized patterns and detected objects in the region, removing invalid regions from the first sensor data, to result in filtered first sensor data, and fusing the filtered first sensor data with the second sensor data to result in fused data.

### TECHNICAL FIELD

Various embodiments relate to environment perception systems and methods for perceiving an environment of a vehicle.

### BACKGROUND

Advanced driver assistance systems and autonomous vehicles rely heavily on sensor data to generate decisions, warnings and guidance to drivers. There is substantial effort put into the development of sensors, such as radars, cameras, ultrasonic sensors and LiDAR sensors, to improve the accuracy, speed and resolution of the sensor data. Each type of sensor has its own advantages and disadvantages. For example, camera systems are suitable for identifying roads, reading traffic signs and recognizing other vehicles, LiDAR systems are superior for accurate determination of vehicle positions, while radars are useful for estimating speed of vehicles. Sensor fusion is the combination of sensor data collected by different types of sensors, and by doing so, it is possible to achieve more than the sum of the individual sensors. For example, it is possible to generate surround view, or three-dimensional views, through sensor fusion. However, a common problem encountered in performing sensor fusion, is the high requirement for computational power and bandwidth to handle the huge data throughput from various sensors. To satisfy the computational requirements, the computers, such as the automated driving control unit (ADCU) in the vehicles typically require expensive hardware such as artificial intelligence accelerators, high-end Application Specific Integrated Circuits and System on a chip. In addition to the costs, the intensive computation requirements also tend to leave little computational resources available to support future functionality or algorithm upgrades.

As such, there is a need for an improved method for perceiving the environments of vehicles, that utilizes less computational resources.

### SUMMARY

According to various embodiments, there is provided a computer-implemented method for perceiving an environment of a vehicle. The method may include segmenting first sensor data into a first plurality of regions, recognizing patterns or detecting objects in each region of the first plurality of regions, classifying each region of the first plurality of regions as one of valid region and invalid region based on at least one of recognized patterns and detected objects in the region, removing invalid regions from the first sensor data, to result in filtered first sensor data, and fusing the filtered first sensor data with the second sensor data to result in fused data.

According to various embodiments, there is a provided an environment perception system for use with a vehicle. The environment perception system may include a first sensor, a second sensor and a processor. The first sensor may be configured to generate the first sensor data. The second sensor may be configured to generate the second sensor data. The processor may be configured to perform the abovementioned computer-implemented method. According to various embodiments, there is provided a vehicle. The vehicle may include the abovementioned environment perception system. The environment perception system may be additionally configured to manoeuvre the vehicle based on the fused data.

Additional features for advantageous embodiments are provided in the dependent claims.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a vehicle according to various embodiments.

FIG. 2 shows an example of an image generated by a camera according to various embodiments.

FIG. 3 shows an example of a scene in front of the vehicle according to various embodiments.

FIG. 4 shows a simplified hardware block diagram of an environment perception system according to various embodiments.

FIG. 5 shows a simplified hardware block diagram of a vehicle according to various embodiments.

FIG. 6 shows a computer-implemented method for perceiving an environment of a vehicle according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the invention may be readily understood and put into practical effect, various embodiments will now be described by way of examples and not limitations, and with reference to the figures.

FIG. 1 shows a vehicle 100 according to various embodiments. The vehicle 100 may be fitted with a heterogenous suite of sensors, such as cameras 102, radar sensors 104, LiDAR sensors 106 and ultrasonic sensors 108. The positions of the plurality of different sensors shown in FIG. 1 are merely illustrative and should not be understood to be limiting.

The vehicle 100 may include a driving function system, which may be for example, part of an advanced driver assistance system or an automated driving system. The driving function system may include a sensor fusion system including a processor 110. Sensing output from the ultrasonic sensors 108 may be useful for path planning and deciding on driving actions such as brake, accelerate, steer or stop. The cameras 102 may include front camera, and may also include surround view cameras. The cameras 102 may include high resolution cameras with different field of views (FOV) to capture views around the vehicle 100. The images generated by the cameras 102 may be processed to perform object detections or recognitions. The camera resolutions may be, for example, in a range of about 1.5 megapixels to 8.3 megapixels, or even higher. The different FOVs may be, for example, in a range of about 45° to 195°, or even larger. In some embodiments, the images generated by multiple cameras 102 may be stitched together to obtain a surround view image data. The surround view image data may include 360 degrees view of the surroundings of the vehicle 100. The processor 110 may be configured to detect objects in the surround view image data. The radar sensors 104 may be of various different ranges and operating frequencies. For example, the ranges may be short range such as 0.5 to 20 metres, medium range such as 1 to 60 metres, or long range such as 10 to 250 metres. As an example, the operating frequencies may be 66 MHz or 77 MHz. Output of the radar sensors may be used to detect objects or traffic participants such as pedestrians, cyclists, motorcycles, tunnels etc.

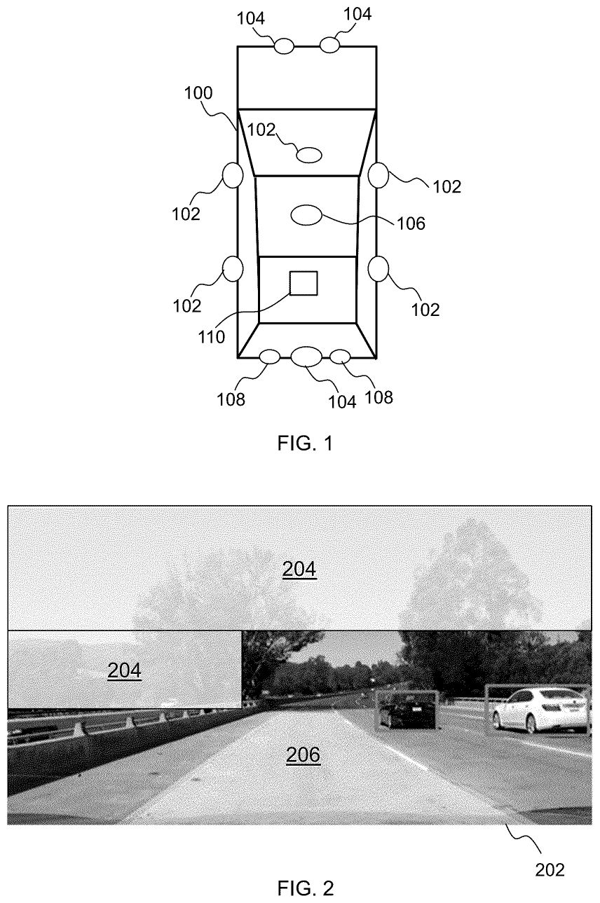

According to various embodiments, a method 600 for perceiving an environment of a vehicle is provided. The method 600 may be implemented using a processor or a computer. The method 600 may combine or fuse the sensor data collected by the suite of sensors in an efficient manner. Not all information in the sensor data is critical to be processed. The method 600 may achieve high efficiency, by processing only selected relevant regions in the sensor data. As mentioned with respect to FIG. 1, a vehicle 100 may be fitted with various sensors and each sensor may provide its respective unique contribution to the perception of the environment. For example, each sensor may capture a different field of view due its position on the vehicle. For example, each sensor may sense the environment using a different mechanism or electromagnetic wavelength. By fusing the sensor data, an enhanced perception of the vehicle surroundings may be achieved. The enhanced perception may be used to improve the driver's driving experience and also road safety. The processor 110 may detect objects of interest more accurately than using a single sensor data, using the fused sensor data. The objects of interest may include other vehicles, pedestrians, road signs, and road mirrors. The processor 110 may construct an augmented view of the environment using the fused sensor data, for example by stitching up the sensor data generated by sensors located at different positions of the vehicle 100. The augmented view may also include annotation derived from a second sensor data, being overlaid on a first sensor data. The considerations in selecting the relevant regions in the sensor data, as performed in method 600, will be discussed with reference to FIG. 2. The method 600 is further described with respect to FIG. 6.

FIG. 2 shows an example of an image 202 generated by a camera 102 according to various embodiments. The image 202 captures a scene on a highway. When the vehicle 100 is travelling on the highway, the driving function system may need to watch out for other vehicles in the same lane. For example, the vehicle 100 may crash into another vehicle in the same lane if the other vehicle brakes suddenly. The driving function system may also need to watch out for other vehicles in adjacent lanes in case the other vehicles cut into the vehicle 100's lane. The driving function system may also look out for traffic signs and road signs, which may indicate the need to slow down or make turns. Other areas in the image 202, including the sky, the road divider, and the lanes beyond the road divider, are irrelevant for the driving function system's processing, as these other areas do not include traffic participants or information of concern to the vehicle 100. The processor 110 may classify these other areas as invalid regions 204. In this context, “regions” are also interchangeably referred to as “tiles”. These invalid regions 204 may be identified based on recognition of patterns such as uniform color tone indicative of sky, or based on detection of objects such as road boundaries or guard rails within a predefined distance, or based on a lack of detected objects of interest such as signs or other vehicles. The predefined distance may be for example, 100 to 200 metres. The processor 110 may ignore the invalid regions 204 when it performs sensor data fusion thereby reducing the data throughput. In an embodiment, the processor 110 may segment the image 202 into a plurality of regions, and may classify each region as either a valid region 206 or an invalid region 204. The processor 110 may mark or label the valid regions 206 with “1”, and may mark the invalid regions 204 with “0”. The processor 110 may process only the regions that are marked as “1”.

According to various embodiments, a particular type of sensor may be important to certain scenarios. For example, the radar sensor 104 may be critical when the vehicle 100 is exiting a tunnel or an overhead bridge. In these scenarios, the processor 110 may send control signals to keep the radar sensor 104 active. Each region may also be labelled with logic as to which sensors may be disabled or enabled for the region. The labelling of the sensor logic for each region is also referred herein as ‘tile invalidation logic”. Disabling or invalidating the sensor may refer to stop the processor 110 from processing data output of the sensor, or may refer to stopping transmission of data from the sensor, or turning off the sensor. If the region is labelled as having two or more sensors being enabled, the processor 110 may perform fusion of the data from these two or more sensors.

Examples of the tile invalidation logic for the regions may include:
Radar: “1” or “0”, where “1” indicates that radar sensor 104 should be enabled and “0” indicates that radar sensor 104 should be disabled.
Camera: “1” or “0”, where “1” indicates that camera 102 should be enabled and “0” indicates that camera 102 should be disabled.
LiDAR: “1” or “0”, where “1” indicates that LiDAR sensor 106 should be enabled and “0” indicates that LiDAR sensor 106 should be disabled.
Radar+Camera: “1” or “0”, where “1” indicates that both radar sensor 104 and camera 102 should be enabled and their data will be combined, i.e. fused, while “0” indicates that both radar sensor 104 and camera 102 should be disabled.
Lidar+Camera: “1” or “0”, where “1” indicates that both LiDAR sensor 106 and camera 102 should be enabled and their data will be combined, i.e. fused, while “0” indicates that both LiDAR sensor 106 and camera 102 should be disabled.

According to various embodiments, the method 600 may include adaptively adjusting the processing rate of sensor data. The processing rate may be adjusted based on at least one of the following factors including visibility, detection of objects etc. For example, in bright lighting conditions such as broad day light, the processing rate may be reduced as the visibility is high and any obstacles or objects can be detected fast. In another example, if there are no objects detected in front and/or at the back of the vehicle 100 for a predetermined time duration, the processor 110 may determine that are no nearby objects and hence, the processing rate of sensor data may be reduced, for example to half frame per second instead of full frame per second. When at least one of the sensors detect an object of interest in a vicinity of the vehicle 100, the processor 110 may adjust the processing rate back to the higher rate.

According to various embodiments, the method 600 may be carried out using at least one neural network. The at least one neural network may be configured to select the relevant regions in the sensor data, or to classify the relevant regions. The at least one neural network may be configured to adaptively label the regions with sensor logic, and also may be configured to adaptively adjust the processing rate of sensor data.

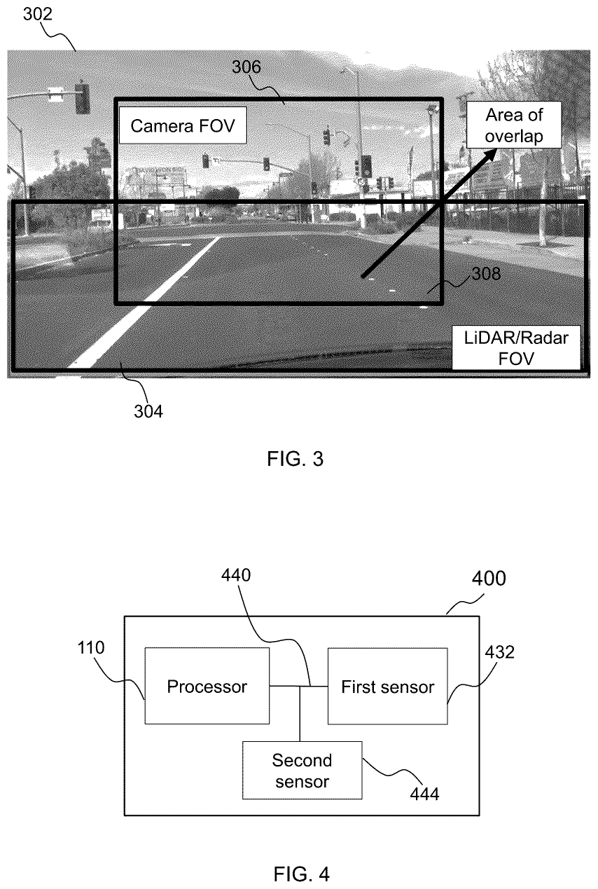

FIG. 3 shows an example of a scene in front of the vehicle 100 according to various embodiments. The method 600 may include dividing the field of view (FOV) of the vehicle 100, and allocating the divided FOV to different sensors. The portion of the FOV that is most likely to see action or have objects detected, may be assigned to a sensor with fast processing rate. The remaining parts of the FOV may be assigned to a secondary sensor with slower processing rate. The overlap between the FOVs may serve to provide confirmation about detected objects. For example, the centre of the FOV may be assigned to the camera 102 as a camera FOV 306, while the lower half of the FOV may be assigned to the radar sensor 104 or the LiDAR sensor 106 or a stereo camera, as a secondary sensor FOV 308. The camera FOV 306 and the secondary sensor FOV 304 may overlap in an overlapping area 308. The centre region may be assigned to the camera 102 as the processing of two-dimensional (2D) camera images may be considerably faster than the three-dimensional (3D) processing of radar or LiDAR data. The 2D data processing may take place in real-time, while the 3D data processing may be carried out at a lower rate, for example, 5 frames per second.

According to various embodiments, the 2D data processing and the 3D data processing may take place at different times. In other words, only one of 2D and 3D data may be processed at any time. This may be referred to as time division multiplexed processing, which allows for using a single computing device, for example, the processor 110, to carry out the data processing for both 2D and 3D data. The detection of objects of interest such as traffic lights, cars, and pedestrians may be carried out using 2D data. Segmentation of the FOV may also be performed using 2D data. The 3D data may be used to build information about the surroundings of the vehicle 100. In the overlapping area 308, the processed 3D data may be used to confirm detections made in the 2D data, and may also be used to detect any objects that were missed out in the 2D data.

According to various embodiments, the processing rate of the sensor data, as well the FOV, may be adaptive. In other words the processing rate and/or the FOV may change with factors such vehicle speed, surrounding object density and the detected horizon. The heterogeneous suite of sensors may simultaneously capture various physical attributes of the environment. Such multimodality and redundancy of sensing may be positively utilized for reliable and consistent perception of the environment through sensor data fusion.

FIG. 4 shows a simplified hardware block diagram of an environment perception system 400 according to various embodiments. The environment perception system 400 may include at least one processor 110. The processor 110 may be, for example, an ADCU. The at least one processor 110 may be configured to carry out the method 600 in any above-described embodiment or any below described further embodiment herein.

The environment perception system 400 may further include a first sensor 432 and a second sensor 444. The first sensor 432 and the second sensor 444 may be of different sensor types. The first sensor 432 may be configured to generate first sensor data. The second sensor 444 may be configured to generate second sensor data. For example, the first sensor 432 may be any one sensor of the camera 102, the radar sensor 104, the LiDAR sensor 106 and the ultrasonic sensor 108, while the second sensor 444 may be any one sensor of the remaining types of sensors. The processor 110, the first sensor 432 and the second sensor 444 may be coupled to one another, for example, mechanically or electrically, via coupling line 440. The environment perception system 400 may be configured to generate control outputs based on fused data. The fused data may result from a fusion of filtered first sensor data with the second sensor data or filtered second sensor data. The control outputs may be transmitted to a driving function control unit of the vehicle 100, to control the driving functions such as braking, accelerating, left and right turns. Consequently, the environment perception system 400 may maneuver the vehicle 100 based on the fused data. The control outputs generated based on the fused data may aid a driver of the vehicle 100 to prevent road accidents, thereby improving road safety.

According to an embodiment which may be combined with any above described environment or with any below described further embodiment, the first sensor may be of a different sensor type from the second sensor. Different types of sensors have their respective strengths and weaknesses, and as such, combining the sensing output of different types of sensors may enhance the perception of the vehicle's environment.

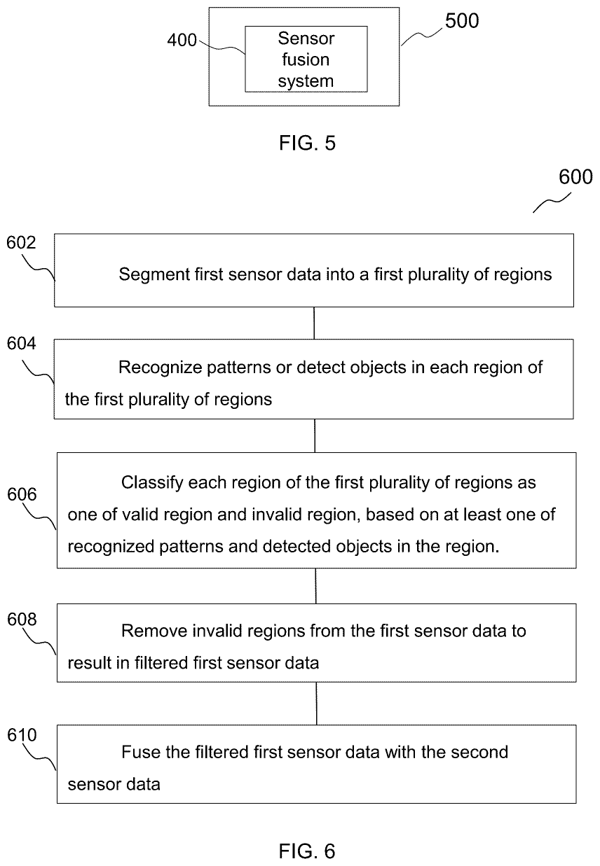

FIG. 5 shows a simplified hardware block diagram of a vehicle 500 according to various embodiments. The vehicle 500 may include, or may be part of, the vehicle 100. The vehicle 500 may include the environment perception system 400.

FIG. 6 shows a computer-implemented method 600 for perceiving an environment of a vehicle according to various embodiments. The method 600 may include processes 602, 604, 606, 608 and 610. The process 602 may include segmenting first sensor data into a first plurality of regions. The process 604 may include recognizing patterns or detecting objects in each region of the plurality of regions. The process 606 may include classifying each region of the first plurality of regions as one of valid region and invalid region, based on at least one of recognized patterns and detected objects in the region. The process 608 may include removing invalid regions from the first sensor data to result in filtered first sensor data. The process 610 may include fusing the filtered first sensor data with the second sensor data, to result in fused data. By excluding the invalid regions of the first sensor data from the data fusion process in 610, the method 600 may improve the efficiency of the data fusion process, such that the computation resources in the processor 110 may be made available to other critical algorithms in the vehicle 100. By processing the data fusion efficiently, the method 600 may also free up computational resources to support future over-the-air (OTA) algorithm updates.

According to an embodiment which may be combined with any above-described embodiment or with any below described further embodiment, the method 600 may further include detecting an object of interest based on the fused data. Objects of interest may be accurately detected due to the fusion of the two sensor data that may capture respective attributes of the object, for example, distance and visual features. The detection may be used to warn the driver of dangerous situations, or guide the driver to make informed decisions. For example, the detected object may be another vehicle that may potentially collide with the vehicle 100, and the driver may be warned to avert the collision. In another example, the detected object may be a STOP sign, and the driver may be informed of the STOP sign in advance so that the driver may decelerate the vehicle 100.

According to an embodiment which may be combined with any above-described embodiment or with any below described further embodiment, the method 600 may further include constructing an augmented view of the environment based on the fused data.

According to an embodiment which may be combined with any above-described embodiment or with any below described further embodiment, the method 600 may further include segmenting second sensor data into a second plurality of regions, and removing regions in the second sensor data that correspond to the invalid regions from the second sensor data. The second sensor data fused with the filtered first sensor data may exclude the removed regions. By also removing invalid regions in the second sensor data before performing data fusion may further improve the efficiency of the method 600, thereby requiring less resources, without substantial impact to the quality of the fused data.

According to an embodiment which may be combined with any above-described embodiment or with any below described further embodiment, the first sensor data and the second sensor data are generated by different types of sensors. Different types of sensors may capture different physical attributes of the environment. Such multimodality and redundancy of sensing may be positively utilized for reliable and consistent perception of the environment through sensor data fusion.

According to an embodiment which may be combined with any above-described embodiment or with any below described further embodiment, the first sensor data or the second sensor data is generated by one of camera, radar, LiDAR and ultrasonic sensors. Each of these sensor types has its own qualities. Cameras may generate images that capture detailed visual information which are suitable for object recognition. Radar sensors may be useful as an all-weather sensor for sensing the presence of objects regardless of the lighting condition. LiDAR sensors may be capable of accurate determination of positions and/or speed of other vehicles. Ultrasonic sensors may be a cost-effective sensor for detecting objects in the near range.

According to an embodiment which may be combined with any above-described embodiment or with any below described further embodiment, recognizing patterns or detecting objects in each region of the first plurality of regions and classifying each region of the first plurality of regions as one of valid region and invalid region, are performed using a classification neural network. By using a classification neural network, a high accuracy of classifying the regions may be achieved. The classification neural network may be trained using a training database of traffic images generated by vehicle sensors.

According to an embodiment which may be combined with any above-described embodiment or with any below described further embodiment, classifying each region of the first plurality of regions as one of valid region and invalid region is further based on type of sensor that generated the second sensor data. Each type of sensor may be configured or best suited to capture a respective physical attribute of the vehicle's environment. As such, classifying the regions as being valid or invalid, i.e. whether to be processed for data fusion, depending on the sensor type may improve the relevance of the regions selected for processing. For example, radar sensor data would not be useful for recognizing the information on a traffic sign, and as such, for radar sensor data, the region with the traffic sign may be classified as invalid. On the other hand, camera images may be suitable for recognizing traffic signs, and as such the region with the traffic sign in a camera image may be classified as valid.

According to an embodiment which may be combined with any above-described embodiment or with any below described further embodiment, the method 600 may further include searching for objects of interest in the first sensor data, to generate for each region of the first plurality of regions, a detection result indicative of number of objects of interest detected within a predefined time duration. The detection result may serve as an indicator of the amount of focus, such as higher frame rate, required for the region.

According to an embodiment which may be combined with any above-described embodiment or with any below described further embodiment, the method 600 may further include adjusting processing rate of each region of at least one of the first sensor data and its corresponding region in the second sensor data, based on the detection result. This optimizes the use of computational resources, by adapting the processing power required according to situational need.

According to an embodiment which may be combined with any above-described embodiment or with any below described further embodiment, adjusting the processing rate of each region of at least one of the first sensor data and its corresponding region in the second sensor data may include setting the processing rate to a high rate based on the detection result indicating at least one object of interest detected within the predefined time duration, and may further include setting the processing rate to a low rate based on the detection result indicating no object of interest detected within the predefined time duration. As a result, more computation resources may be allocated to a region where objects of interest are spotted, to obtain more information on the detected objects. Conversely, computational resources may be conserved or diverted to other regions, when there is no activity spotted in the region, to achieve optimization of resource usage.

According to an embodiment which may be combined with any above-described embodiment or with any below described further embodiment, fusing the filtered first sensor data with the second sensor data results in generating 2D data for the regions with high processing rate and 3D data for the regions with low processing rate. 2D data may require less processing power than 3D data, and therefore may be processed faster than the 3D data.

According to an embodiment which may be combined with any above-described embodiment or with any below described further embodiment, processing of the 2D data and the 3D data may be time-division multiplexed. By doing so, the same processor 110 or computing chip, may be used to process both the 2D and 3D data. The 2D and 3D data may be generated by different types of sensors.

According to an embodiment which may be combined with any above-described embodiment or with any below described further embodiment, fusing the filtered first sensor data with the second sensor data may include substituting the invalid regions of the first sensor data with regions in the second sensor data that correspond to the invalid regions of the first sensor data, wherein the second sensor data has a lower frame rate than the first sensor data. The invalid regions of the first sensor data may be of lesser priority as compared to the valid regions, and as such they may be replaced by the lower frame rate data from the second sensor to complete the FOV while reducing the data throughput.

Various aspects described with respect to the method 600 may be applicable to the sensor fusion system 400 and the vehicle 500.

According to various embodiments, the method 600 may be at least partially performed using at least one neural network. The at least one neural network may include a classification neural network. The classification neural network may be trained to recognize patterns or to detect objects in each region of the first plurality of regions. The classification neural network may be further configured to classify each region of the first plurality of regions as one of valid region and invalid region.

The at least one neural network may include a labelling neural network. The labelling neural network may be trained to adaptively label the regions with sensor logic.

The at least one neural network may include a rate adjustment neural network. The rate adjustment neural network may be configured to adaptively adjust the processing rate of sensor data.

According to various embodiments, at least one of the classification neural network, the labelling neural network and the rate adjustment neural network may include a convolutional neural network (CNN) based model, such as YOLO, SSD, PointNet etc. The inputs to these networks may include sensor data generated by the suite of sensors, such as red-green-blue (RGB) images from the camera 102, Radar Doppler Impulse (RDI) image from the radar sensor 104 and point cloud from the LiDAR sensor 106. The training data may include synthetic data, semantic segmented image input and driving scene images. The training data may include images that are segmented into regions and where each region is labelled as valid or invalid. The training data may include two labels-valid and invalid. The training data may include a mix of video recordings, radar detection data, LiDAR point cloud, and synthetic data from game engines.

According to various embodiments, each of the classification neural network, the labelling neural network and the rate adjustment neural network may include a respective neural network trained specifically for a respective sensor type. For example, a radar neural network may be trained to determine which radar image region is valid or invalid, whereas a camera neural network may be trained to determine which camera image region is valid or invalid. The output of these neural networks may be classified, i.e. categorized sensor data that indicates which regions of the sensor data are “valid” and which regions are “invalid”. The valid regions may be important for further processing while the invalid regions may be unimportant for further processing.

According to various embodiments, the at least one neural network may include a fusion neural network configured to fuse the sensor data. The fusion neural network may include a CNN based model combined with Kalman fusion or decision networks.

The training process of the at least one neural network is described in the following paragraphs.

Before training the neural network 1000, the weights may be randomly initialized to numbers between 0.01 and 0.1, while the biases may be randomly initialized to numbers between 0.1 and 0.9.

Subsequently, the first observations of the dataset may be loaded into the input layer of the neural network and the output value(s) is generated by forward-propagation of the input values of the input layers. Afterwards the following loss function may be used to calculate loss with the output value(s):

Mean Square Error (MSE):

$$MSE = \frac{1}{n} \sum {( y - \hat{y} )}^{2} ,$$

where n represents the number of neurons in the output layer and y represents the real output value and ŷ represents the predicted output. In other words, y−ŷ represents the difference between actual and predicted output.

The computed error may be backpropagated and the weights may subsequently be updated.

The steps described above may be repeated with the next set of observations until about 60% of the observations are used for training. This may represent the first training epoch, and may be repeated until 5 epochs are done. Different epochs may be performed to verify that the neural network output converges. The remaining 40% of the observations may be used for the verification. The above described process may be performed using batch learning. The training parameters may be adjusted and refined until the neural network converges, errors are reduced and performance is improved. The training parameters may include learning rate, weight degradation, moment values, regularization rate, number of iterations, number of cycles, and set size. The performance may be monitored using the Improved Confusion matrix and the Improved Precision/Recall or F Score.

According to various embodiments, other loss functions may be used in the at least one neural network. For example, the Regression Loss Function or the Mean Squared Logarithmic Error Loss function may be used for a neural network processing camera images, while the cross entropy function may be used for a neural network processing radar images.

An example of a suitable public training dataset may be the KITTI data.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

1-16. (canceled)

17. A computer-implemented method for perceiving an environment of a vehicle, the method comprising:
segmenting first sensor data into a first plurality of regions;
recognizing patterns or detecting objects in each region of the first plurality of regions;
classifying each region of the first plurality of regions as one of valid region and invalid region, based on at least one of recognized patterns and detected objects in the region;
removing invalid regions from the first sensor data, to result in filtered first sensor data; and
fusing the filtered first sensor data with the second sensor data, to result in fused data.

18. The method of claim 17, further comprising:
detecting an object of interest based on the fused data; and/or
constructing an augmented view of the environment based on the fused data.

19. The method of claim 17, further comprising:
segmenting second sensor data into a second plurality of regions; and
removing regions in the second sensor data that correspond to the invalid regions from the first sensor data,
wherein the second sensor data fused with the filtered first sensor data excludes the removed regions.

20. The method of claim 17, wherein the first sensor data and the second sensor data are generated by different types of sensors.

21. The method of claim 17, wherein the first sensor data or the second sensor data is generated by one of camera, radar sensor, LiDAR sensor, and ultrasonic sensors.

22. The method of claim 17, wherein recognizing patterns or detecting objects in each region of the first plurality of regions and classifying each region of the first plurality of regions as one of valid region and invalid region, are performed using a classification neural network.

23. The method of claim 17, wherein classifying each region of the first plurality of regions as one of valid region and invalid region is further based on type of sensor that generated the second sensor data.

24. The method of claim 17, further comprising:
searching for objects of interest in the first sensor data, to generate for each region of the first plurality of regions, a detection result indicative of number of objects of interest detected within a predefined time duration.

25. The method of claim 24, further comprising:
adjusting processing rate of each region of at least one of the first sensor data and its corresponding region in the second sensor data, based on the detection result.

26. The method of claim 25, wherein adjusting the processing rate of each region of at least one of the first sensor data and its corresponding region in the second sensor data comprises setting the processing rate to a high rate based on the detection result indicating at least one object of interest detected within the predefined time duration, and further comprises setting the processing rate to a low rate based on the detection result indicating no object of interest detected within the predefined time duration.

27. The method of claim 26, wherein fusing the filtered first sensor data with the second sensor data results in generating two-dimensional data for the regions with high processing rate and three-dimensional data for the regions with low processing rate.

28. The method of claim 17, wherein processing of the two-dimensional data and the three-dimensional data is time-division multiplexed.

29. The method of claim 17, wherein fusing the filtered first sensor data with the second sensor data comprises substituting the invalid regions of the first sensor data with regions in the second sensor data that correspond to the invalid regions of the first sensor data, wherein the second sensor data has a lower frame rate than the first sensor data.

30. An environment perception system for use with a vehicle, the environment perception system comprising:
a first sensor configured to generate the first sensor data;
a second sensor configured to generate the second sensor data; and
a processor configured to perform a method for perceiving an environment of a vehicle, the method comprising
segmenting first sensor data into a first plurality of regions,
recognizing patterns or detecting objects in each region of the first plurality of regions,
classifying each region of the first plurality of regions as one of valid region and invalid region, based on at least one of recognized patterns and detected objects in the region,
removing invalid regions from the first sensor data, to result in filtered first sensor data, and
fusing the filtered first sensor data with the second sensor data, to result in fused data.

31. The environment perception system of claim 30, wherein the first sensor is of a different sensor type from the second sensor.

32. The environment perception system of claim 30, wherein the method performed by the processor further comprises:
segmenting second sensor data into a second plurality of regions; and
removing regions in the second sensor data that correspond to the invalid regions from the first sensor data,
wherein the second sensor data fused with the filtered first sensor data excludes the removed regions.

33. The environment perception system of claim 30, wherein the method performed by the processor further comprises:
searching for objects of interest in the first sensor data, to generate for each region of the first plurality of regions, a detection result indicative of number of objects of interest detected within a predefined time duration.

34. The environment perception system of claim 30, wherein the method (600) performed by the processor further comprises:
adjusting processing rate of each region of at least one of the first sensor data and its corresponding region in the second sensor data, based on the detection result;
wherein preferably adjusting the processing rate of each region of at least one of the first sensor data and its corresponding region in the second sensor data comprises
setting the processing rate to a high rate based on the detection result indicating at least one object of interest detected within the predefined time duration, and further comprises setting the processing rate to a low rate based on the detection result indicating no object of interest detected within the predefined time duration, and
wherein preferably fusing the filtered first sensor data with the second sensor data results in generating two-dimensional data for the regions with high processing rate and three-dimensional data for the regions with low processing rate.

35. A vehicle comprising an environment perception system for use with a vehicle, the environment perception system comprising:
a first sensor configured to generate the first sensor data;
a second sensor configured to generate the second sensor data; and
a processor configured to perform a method for perceiving an environment of a vehicle, the method comprising
segmenting first sensor data into a first plurality of regions,
recognizing patterns or detecting objects in each region of the first plurality of regions,
classifying each region of the first plurality of regions as one of valid region and invalid region, based on at least one of recognized patterns and detected objects in the region,
removing invalid regions from the first sensor data, to result in filtered first sensor data, and
fusing the filtered first sensor data with the second sensor data, to result in fused data.

36. The vehicle of claim 35, wherein the environment perception system is additionally configured to manoeuvre the vehicle based on the fused data.
